(19) United States
(12) Patent Application Publication
(10) Pub. No.: US 2005/0002069 A1
(43) Pub. Date: Jan. 6, 2005

(54) Device and method for scanning an original copy involving a lifting and rotational movement of a camera

(76) Inventors: Markus Schnitzlein, Radolfzell (DE); ARnold Allweier, Allensbach (DE)

Correspondence Address: SCHIFF HARDIN, LLP;PATENT DEPARTMENT, 6600 SEARS TOWER, CHICAGO, IL, 60606-6473, US

(21) Appl. No.: 10/496,348

(22) PCT Filed: Nov. 19, 2002
(86) PCT No.: PCT/EP02/12961

(30) Foreign Application Priority Data
Nov. 23, 2001 (DE) 101 57 574.2
Feb. 27, 2002 (DE) 102 08 384.3

(51) Int. Cl. H04N 1/21; H04N 1/04

(52) U.S. Cl. 358/483; 358/302; 358/497

(57) ABSTRACT

Device and method are provided for scanning an original copy using a camera containing a line sensor. During the scanning process, an optical path length between the camera and each line being currently scanned is maintained substantially constant.

### BACKGROUND

A device to scan an original, with a bearing surface on which the original to be scanned rests is known. The device has a camera, provided with an optoelectronic line sensor, that scans the original resting on the bearing surface line-by-line and generates electronic signals.

Such a device is used to digitize the image content of an original such as, for example, magazines and books. Such originals are frequently bound, such that it is necessary to lay the original open on a work table and scan from above using the incident light principle.

In the prior art, scanning devices (scanners) are known that use a camera with a CCD area sensor. Such a camera can in fact implement a fast scan, however the resolution of the image structures are significantly limited. At very high resolutions, the CCD sensors necessary for this are very cost-intensive. In particular, cameras that comprise a CCD line sensor are therefore used. Such a camera has a high resolution with high quality and operates economically.

Given the use of a camera with a CCD line sensor, two tasks are too be solved. On the one hand, to generate a two-dimensional image, a relative motion between the scanning camera and the original must occur, for example by shifting the camera, and the original, the objective of the camera or the line sensor. On the other hand, it is necessary to sufficiently illuminate the original, in particular the line to be scanned.

In a conventional scan with a camera with line sensor, the camera is located above the original and is moved across the entire document. What is disadvantageous is that the camera must be moved over a relatively long extent, and this motion occurs in the head room of a user. A further disadvantage is that it is difficult to place an illumination such that no glare that impairs the scan quality is present in the image to be scanned.

A further possibility of scanning is to arrange the camera with the line sensor perpendicular and fixed above the original, and to shift the objective of the camera such that a larger area of the original is scanned line-by-line. This is difficult since the optics must be designed for a large image area, and the image region should correspond at least to the diagonals of the maximum original size. Moreover, the problem exists of the occurrence of glare on the image structure to be scanned.

In the prior art, halogen or fluorescent lamps are frequently used to illuminate the original. However, such lamps are disadvantageous insofar as they exhibit a slow warm-up behavior, and wherein the color and the brightness change, whereby the scan result also changes. Moreover, the original is exposed to a relatively high radiant heat and, in the case of fluorescent lamps, additionally a UV exposure. A further disadvantage is visible in that such lamps interfere in the work area of an operator and can cause a diaphragm effect at the operator. Moreover, a whole-surface illumination with the aid of such lamps generates glare on the original to be scanned, with the result of reduced scan quality.

From EP-A-0 164 713, a document reader is known in which a line camera executes a lifting motion and a rotation movement upon line-by-line scanning. The optical distance between the camera and the document to be read remains essentially constant.

A scanner head to scan originals is known from the German patent DE 19 829 776 C1. The distance between the sensor and the original remains essentially equal, for which a parallelogram mechanism is used. A radiation source that comprises a plurality of LEDs serves to illuminate the original.

### SUMMARY

It is an object to specify a device and a method to scan an original that is simply designed and enables a precise scan with high quality.

A method and device are provided to scan an original. The original to be scanned rests on a support surface. The camera is provided with an opto-electronic lens sensor which scans the original line-by-line. An optical path length between the camera and each current line being scanned is kept essentially constant.

### BRIEF DESCRIPTION OF THE DRAWINGS

FIG. 1 is a principle representation of the device with two camera positions;

FIG. 2 is a design with a single drive motor;

FIG. 3 is a design with two drive motors;

FIG. 4 is a design with a rotating mirror;

FIG. 5 is an illumination arrangement with integrated camera;

FIG. 6 is a design of an illumination by means of LED rows;

FIG. 7 is a similar design in a compact arrangement;

FIG. 8 is a further exemplary embodiment with a pivotable arm, on which is arranged the camera such that it can be linearly moved;

FIG. 9 is the arrangement according to FIG. 8 with a spindle-nut combination;

FIG. 10 is an arrangement with a curve disc that effects the linear motion of the camera on the arm; and

FIG. 11 is a further arrangement in which a movable diaphragm is used.

### DESCRIPTION OF THE PREFERRED EMBODIMENTS

For the purposes of promoting an understanding of the principles of the invention, reference will now be made to the preferred embodiments illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

A system is provided that keep the optical path length between the camera and the current line to be scanned essentially constant during the scan event. The optics for the camera must only be designed for the length of a line on the original to be scanned, typically for the width of the original. A design of the optics for the entire image diagonal and the entire area of the original is not necessary. The design for the camera is accordingly simplified. Moreover, the optics can be optimally designed to the constant optical path length, such that no optical distortions can be created. A refocusing or a change of the scale, as in known scanning systems, is not necessary.

In preferred exemplary embodiments, the camera is arranged on an arm such that it can be moved. The arm is connected with one end in a stationary rotation axle with a lifting column, such that it can be pivoted. Given a pivot movement of the arm, the camera is also simultaneously shifted on this arm, whereby the consistent distance from the line to be scanned is maintained.

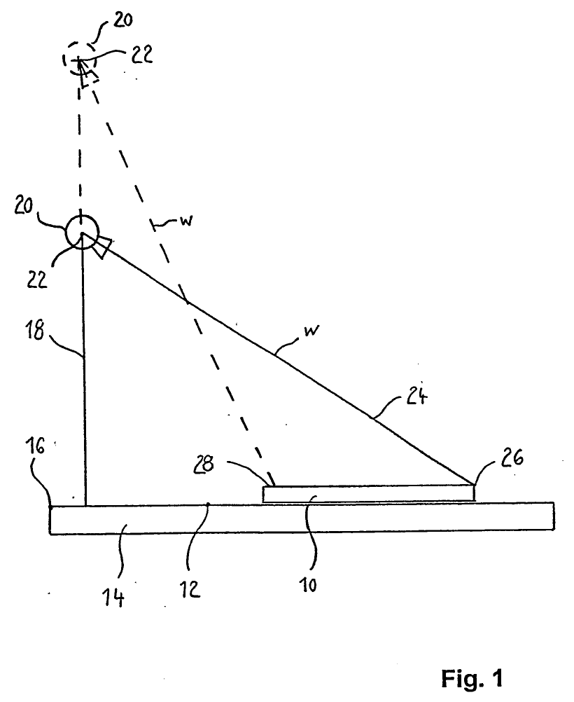

FIG. 1 shows a principle representation of the preferred embodiment. An original 10, for example a bound book or a bound magazine, lies open on the bearing surface 12 of a work table 14. One edge of the original 10 is generally aligned parallel to a reference axis, for example the trailing edge 16 of the work table. A camera 20 can be moved along a lifting column 18 that is attached to the work table 16. The camera 20 comprises an objective and an optoelectronic line sensor, generally a CCD line sensor. The line sensor is preferably arranged in a rotation center 22 around which the camera 20 can rotate.

The camera 20 is aligned with its objective such that a center beam detects a boundary line 26 to be scanned that has the maximum distance from the reference axis 16. The direction of the line and the arrangement of the linear line sensor in the camera 20 runs perpendicular to the paper plane of FIG. 1. The optical path length w between the camera 20 and the boundary line 26 is a constant quantity to which the objective of the camera 20 is optimally adjusted. In the line-by-line scan of the original 10, the camera 20 is moved upwards (indicated dashed) along the lifting column 18, whereby the camera 20 rotates around the rotation center 22 such that its optical axis coincides with the center ray. The optical path length w remains constant and acquires in the upper position of the camera 20 a wider boundary line 28 that has minimal distance from the reference axis 16. The line-by-line scan occurs during the movement of the camera 20 from the first position (line drawn solid) to the second position (line drawn dashed), whereby electronic signals are generated for the digitization of the image content of the original. The movement is adapted to the area between the boundary lines 26, 27 and can be selected correspondingly larger or smaller on the bearing surface 12.

As is visible using the principle drawing according to FIG. 1, the camera 20 must only be moved over short distances. The movement of the camera 20 is generally outside of the area that is accessible to an operating personnel to the right of the boundary line. The optics of the camera 20 must only be designed for the scanning in the line direction, for example corresponding to the width of the original 10, or for the width of the support surface 12, and not for the total dimensions of the original 10, for example the image diagonals. Since the optical path length 2 remains constant, a refocusing of the camera is not necessary. Also, no scale changes thereby result. The optics can optimally be adapted to the path length w and can be minimized with regard to distortions. Via the alignment of one edge of the original with regard to a reference axis 16, for example the trailing edge of the work table 14, the entire area behind the original 10 is available for the placement of illumination elements. Barely any glare reflections are created given the arrangement of corresponding illumination elements, also given significantly curved originals (such as, for example, bound books).

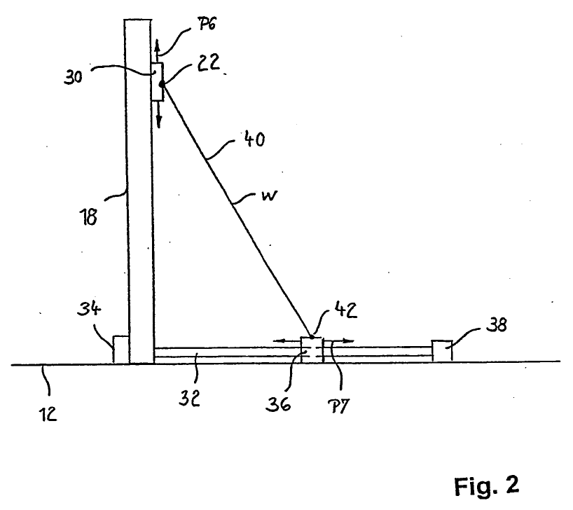

FIG. 2 shows an example that uses a single drive motor. Identical parts are designated identically. A lifting device 30 can be linearly shifted along the lifting column 18, along the indicated arrows P6. A spindle 32 that is driven by a drive motor 34 is arranged along the support surface 12. A slide 36 that can execute linear motions corresponding to the drawn arrow P7 is driven along the spindle 32. The spindle 32 is arranged in a bearing block. The lifting device 30 and the shifting slider 36 are connected with one another by a strut 40, whereby the strut 40 is linked such that it can rotate in an axis belonging to the rotation center 22. The strut 40 is likewise attached to the shift slider 36 such that it can rotate in an axis 42. The distance of the strut 40 between the points 22 and 42 corresponds to the optical path length w.

The camera (not shown in FIG. 2) is arranged on the lifting device 30, whereby the optical axis of the camera is aligned in the direction of the strut 40. The line sensor of the camera is arranged at the height of the rotation center 22. The motor 34 drives the spindle 32 such that the shift slider 36 has a speed in the direction transverse to the line direction of the scanned line, the speed corresponding to the line feed speed given line-by-line scanning. During the shift motion of the shift slider 36, the lifting device 30 is also shifted via the strut 40, and the camera is rotated at the rotation center 22. The lower rotation center 42 is preferably arranged in the object plane, meaning in the scan plane for the original 10. During the line-by-line scan of the original 10, a lifting motion occurs for the camera with regard to the support surface 12, and a rotation motion occurs transverse to the line direction.

In an alternative embodiment of the example according to FIG. 2, a drive is connected with the lifting device 30. The shift slider 36 then follows the driven motion of the lifting device 30.

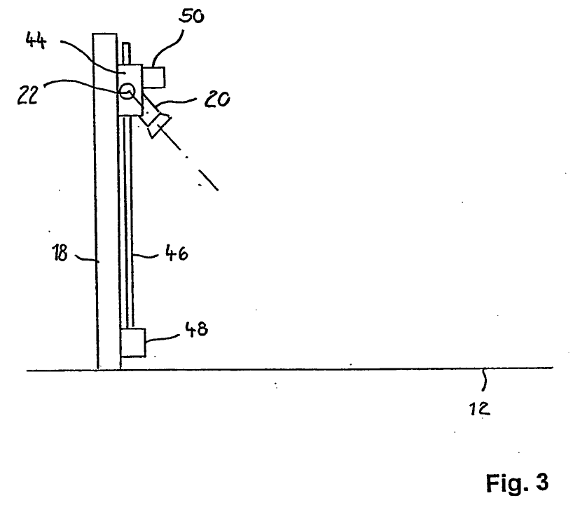

FIG. 3 shows a further exemplary embodiment of the invention. The camera 20 is arranged on a positioning unit 44 that is driven via a spindle 46 and a motor 48 such that it can move along the lifting column 18. The positioning unit 44 bears a rotation device 50 that is rotationally adjusted by a further motor (not shown). Given the line-by-line scanning of the original, the position of the camera 20 is adjusted by both motors such that the distance between the camera 20 and the current line to be scanned is kept essentially constant. The drive curves of both motors must be tuned to one another such that the required combined rotation and lifting motion is executed. The advantage of this example according to FIG. 3 lies in the compact design.

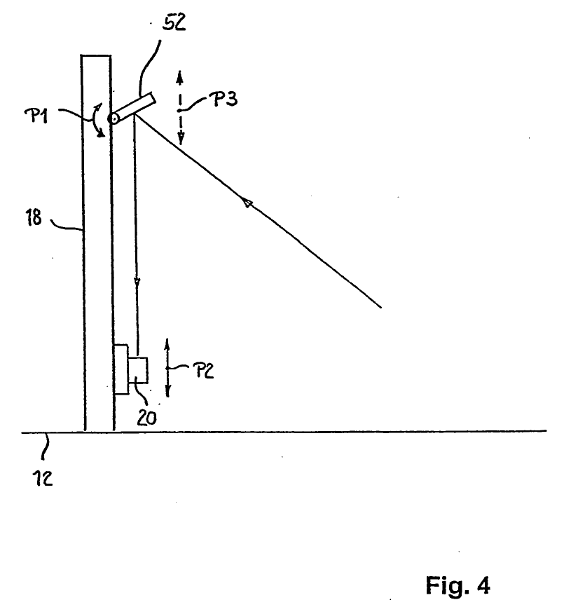

FIG. 4 shows a further example in which a mirror 52 that can be rotated around the arrow P1 is arranged on the lifting column. The camera 20 is also arranged on the lifting column 18. The mirror 52 is provided in the beam path between camera 20 and scanned line. The line feed upon scanning is effected by adjustment of the rotation angle P1 of the rotating mirror 52. The lifting motion can occur either via adjustment of the camera 20 in the direction of the double arrow P2 or via adjustment of the rotating mirror 52 in the direction of the double arrow P3 (drawn dashed). The camera 20 can be installed fixed given a movement of the rotating mirror 52 in the direction of the double arrow P3.

As already mentioned previously, sufficient space exists in the selected arrangement to provide an illumination device that illuminates the original. An illumination unit that generates a ray band along the currently scanned line is preferably used to illuminate the original 10 during the scan event.

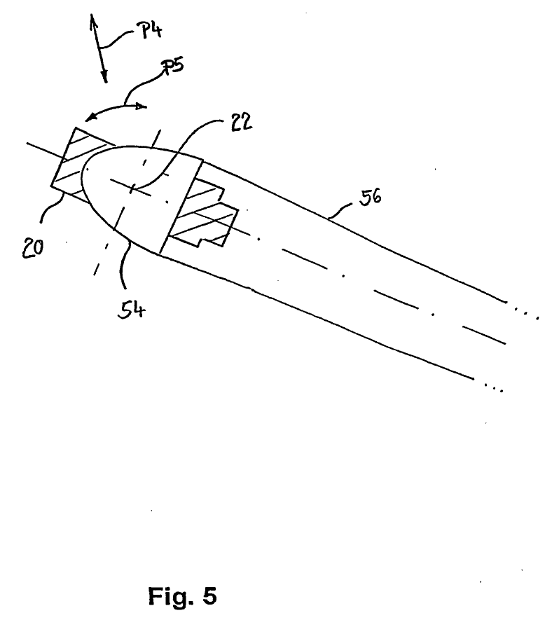

FIG. 5 shows a preferred exemplary embodiment in which the camera 20 is incorporated in an illumination unit 54. As mentioned, the camera 20 executes a linear motion corresponding to the arrow P4 and a rotation movement around the rotation center 22, corresponding to the arrow P5. The illumination unit 54 simultaneously rotates with the camera 20 around the common rotation center 22 and generates a ray band 56 that illuminates the current line to be scanned. Via the common shifting and rotation of camera and illumination unit 54, the radiation band also remains the same in terms of its properties on the original during the shifting motion, whereby, for example, the brightness curve always remains constant in the scanning.

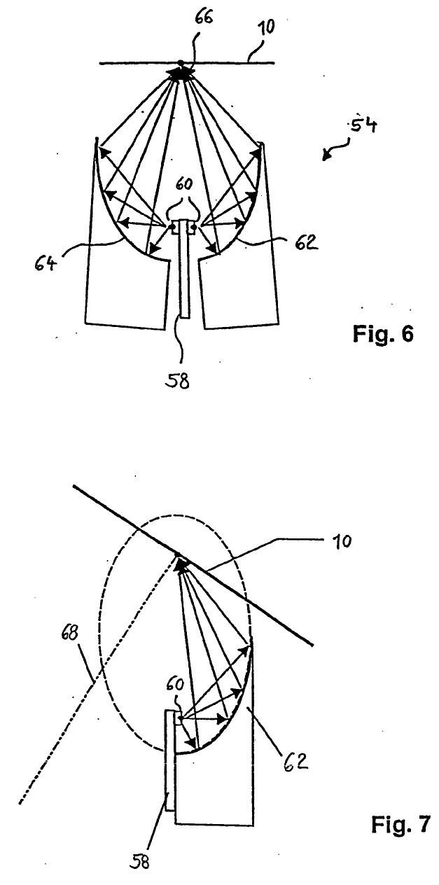

FIG. 6 shows an example for an illumination unit 54 for line-by-line illumination of the original 10. LEDs 60 are arranged in lines on both sides of a circuit board 58. These LEDs are arranged along a first focal line of two elliptical cylinder mirror elements 62, 64. These mirror elements 62, 64 focus the radiation in their respective second mutual focal line 66, that spatially coincides and illuminates the line on the original 10. The shown illumination unit 54 has a compact design since the emission characteristic of the LEDs, which emit radiation only in a half-space, is linked with the advantageous figure projection properties of the elliptical mirror elements 62, 64. The camera 20 can be arranged in a center region of the circuit board, along the longitudinal axis of the circuit board 58.

FIG. 7 shows a design with only one line of LEDs 60 on the circuit board 58. The elliptical mirror 62 is directly connected with the circuit board 58, whereby an assembly simpler in terms of design results. The line to be illuminated is slightly tilted relative to the vertical in which the circuit board 58 lies. The line-shaped illuminated object can be scanned in the axial direction 68 with the aid of the camera 20 (not shown).

Further examples for an illumination unit that can illuminate the original 10 line-by-line are specified in DE 10108075 by the same applicant. The content of this document is hereby included by reference in the disclosure content of the present application.

The specified illumination unit 54 has a plurality of advantages. Only a narrow light stripe is generated, such that a gating of the user in the operating region is prevented. The original itself is charged with a relatively low radiation energy, and thus with a low heat. The use of LEDs allows a fast activation and deactivation without brightness changes. A permanent effect of radiation on the original is prevented. Given use of polychromatic LEDs that, for example, emit white light, a UV charge is foregone. Furthermore, the energy consumption is comparably low.

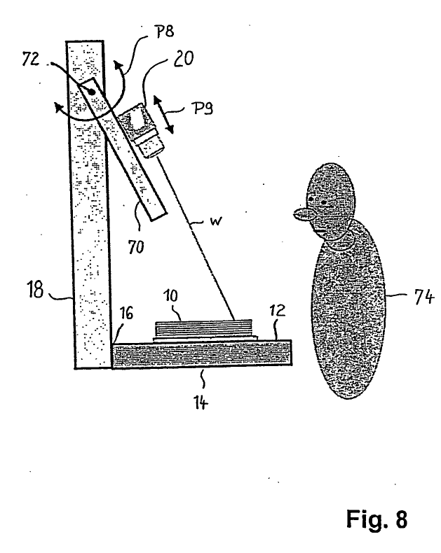

FIGS. 8, 9 and 10 show exemplary embodiments in which the rotation axle for the rotation motion of the camera with constant height is arranged on the lifting column. The identical parts are also designated identically in these examples.

In FIG. 8, an arm 70 that can be pivoted according to the rotation arrow P8 is positioned on the lifting column 18 in a stationary rotation axle 72. The arm 70 bears the camera 20 that is positioned (for example, in a rail) such that it can be shifted relative to the arm 70 in the direction of the arrow P9. The arm 70 is pivoted in the direction of the rotation arrow P8 upon scanning of a line on the original 10. The camera 20 is simultaneously shifted in the direction of the arrow P9, such that the optical path length w between the camera 20 and the current line to be scanned remains essentially constant during the scan event. In this manner, a compact design is given, such that an operating personnel 74 has a large access space to the original 10. The rotation axle 72 is stationary for a predetermined work surface. To change the scan angle or the size of the scan area, this rotation axle 72 can also adopt different positions in terms of height along the lifting column 18.

The line-by-line scanning of the original 10 occurs via rotation of the arm 70 around the rotation axle 72. To compensate the distance change, the camera 20 is linearly shifted on the arm. To pivot the arm 70 and the shift the camera 20, motor units driven independently from one another can be used whose respective motion is coordinated by a control program. The rotation motion and linear shifting motion preferably occurs with the aid of a single motor drive.

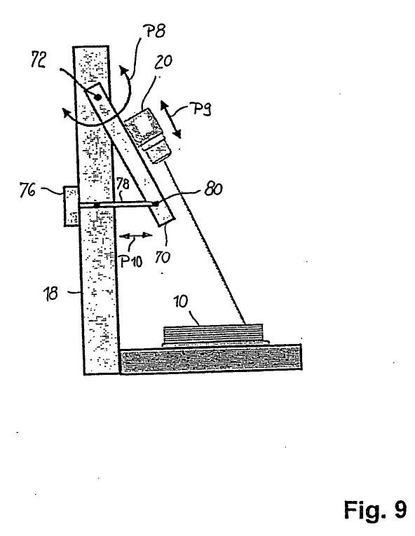

FIG. 9 shows an example for the realization of the pivot motion. A motor 76 is mounted stationary on the lifting column 18. A linear motion in the direction of the arrow P10 can be generated with the aid of a spindle-nut combination. The end of the spindle is connected at the point 80 such that it can be rotated with the arm 70.

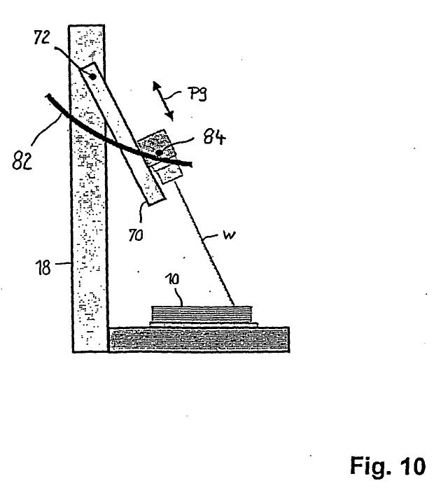

FIG. 10 shows the realization of the relative motion of the camera 20 on the arm 70. This example can preferably be combined with the example according to FIG. 9. A curve disc 82 is connected firmly with the lifting column 18. A pin 84 connected with the camera 20 slides on this curve disc 82. Given a pivoting motion of the arm 70 with constant speed, the camera 20 is shifted relatively on the arm 72 dependent on the curve course and angle of the arm 70, whereby the optical path length w between the camera 20 and the current line to be scanned is held constant. The exemplary embodiment according to FIG. 10 has a particularly simple design and requires only a single motor unit with which the pivot motion of the arm 70 is generated with largely constant angular velocity.

The exemplary embodiments according to FIGS. 8 through 10 can also be advantageously combined with the illumination arrangements according to FIGS. 5 through 7.

A fundamental problem in the image scanning with the aid of a camera exists in the homogenous and efficient illumination of the original to be scanned. The illumination geometry must be selected such that no direct reflections of the radiation emitted by the light source arrives at the camera. Such reflections lead to significant artifacts in the acquired scan images. Primarily when the originals are placed on a glass plate or similar unit for definite alignment of the acquisition geometry, the illumination must be selected such that a direct reflection is prevented. For example, the light source is conventionally positioned far away at a flat angle so that no direct reflected light can arrive at the camera. However, this procedure leads to an inefficient use of the emitted light quantity. Nevertheless, in order to achieve a high image quality, whereby a small diaphragm opening of the imaging optics is necessary, the amount of light is typically increased. However, this is in direct contradiction to a gentle treatment of the object, above all given valuable and sensitive originals. The charge of the original with heat and light energy, in particular of UV light, and the ergonomic problems for the operating personnel created thereby, is critical. In particular for incident light scanners with which books, antique scripts and other large-format originals are scanned, the charge via diaphragm and heat radiation is significant for the operating personnel.

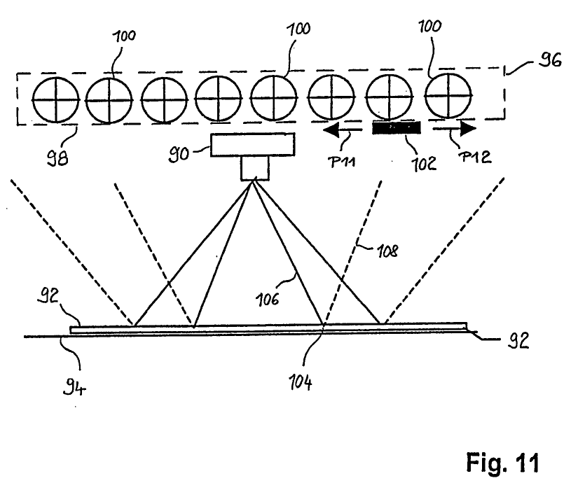

In FIG. 11, an example is shown as to how interfering effects due to glare and direct reflection can be prevented given high utilization of the incident light quantity. In FIG. 11, a camera scans an original 94 arranged beneath a glass plate 92 line-by-line, as this has already been specified further above. An illumination device 96 with a large-surface radiating area 98 emits radiation onto the original 94. The illumination device 96 can comprise a plurality of light sources 100. The illumination device 96 is arranged directly above the original 94, and thus emits radiation directly onto the original 94 and the glass plate 92, such that the radiation radiated by the light sources 100 is optimally used.

A movable diaphragm 102 that can be moved in the arrow directions P11, P12 transverse to the line direction is arranged in front of the radiant surface 98. The line direction here runs perpendicular to the paper plane. In tune with the line-by-line scanning of the camera, the diaphragm 102 is moved to a position in which it screens radiation (originating from the illumination device 96) that would otherwise arrive at the camera 90 via reflection in the scanning of a current line. When, for example, the camera 90 scans a current line 104 on the original 94, a reflection optical path results with the legs 106, 108, whereby radiation from the illumination device 96 that impinges along the leg 108 effects a glare effect, or a direct reflection would be caused on the glass plate 92 or the original 94 in the direction of the camera 90. Based on the position of the diaphragm 102 indicated in FIG. 11, the radiation is gated along the leg 108, and this negative effect is suppressed. Via the diaphragm 102, only a small reduction of the radiation quantity radiated by the illumination device 96 occurs, because the diaphragm 102 can be implemented relatively small in comparison with the large-surface radiant area 98.

The example according to FIG. 11 can be combined with the additional examples specified before. The camera 90 can be movable, or can be arranged at a fixed location in order to effect the line-by-line scanning via rotation motion or via optical means. The glass plate 92 can be coated or omitted entirely. The light sources 100 can have different embodiments, as also already mentioned previously.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

1-33. (Cancelled)

34. A device to scan an original, comprising:
a support surface on which the original to be scanned rests;
a camera provided with an optoelectronic line sensor that scans the original resting on the support surface line-by-line and generates electronic signals;
the camera is arranged on an arm so that the camera can be shifted with respect to the arm;
the arm is connected at one end to a rotation axle that is stationary during the scanning but which allows the arm to pivot with respect to a support for said rotation axle; and
an optical path length between the camera and each current line being scanned remaining essentially constant.

35. A device according to claim 34 which the arm is pivoted and simultaneously the camera is linearly shifted on the arm for line-by-line scanning.

36. A device according to claim 34 in which the arm is pivoted by a motor-driven linear pivoting device.

37. A device according to claim 36 in which the pivoting device comprises a spindle-nut device and is connected with a column supporting the rotation axle.

38. A device according to any of the claims 34 in which, for linear shifting of the camera on the arm, a curved disc is provided via which the camera is shifted relative to the arm given pivot motion of the arm.

39. A device according to claim 38 in which the camera is connected with a pin that rests on the curved disc.

40. A device according to any of the claims 34 in which the rotation axle is set at different height positions on a lifting column.

41. A device according to claim 34 in which a work table is provided that forms the support surface.

42. A device according to claim 41 in which a reference axis is formed by a side edge of the work table.

43. A device to scan an original, comprising:
a support surface on which the original to be scanned rests;
a camera provided with an optoelectronic line sensor that scans the original resting on the support surface line-by-line and generates electronic signals; and
a support for the camera which keeps an optical path length between the camera and each current line being scanned essentially constant.

44. A device according to claim 43 in which, to keep the distance constant, a lifting motion occurs in relation to the support surface, and a rotation motion is provided of the camera transverse to a direction of the lines being scanned.

45. A device according to claim 43 in which a work table is provided that forms the support surface.

46. A device according to claim 45 in which a reference axis is formed by a side edge of the support surface.

47. A device according to claim 45 in which the work table comprises a lifting column arranged in an area removed from an operating region.

48. A device according to claim 47 in which the camera is linearly moved on a lifting device along the lifting column;
a shifting device is linearly moved along the work table, transverse to line direction; and
the lifting device and the shifting device are respectively coupled with one another at their ends via a strut so that they can rotate.

49. A device according to claim 48 in which the line sensor of the camera lies at a rotation center of the lifting device, and in which an optical axis of the camera runs essentially in a direction of the strut.

50. A device according to claim 48 in which the shifting device comprises a spindle driven by a motor with constant speed, corresponding to a line feed speed in the line-by-line scanning.

51. A device according to claim 47 in which the camera is mounted on a positioning unit;
the positioning unit is shifted along the lifting column with the aid of a first motor;
a rotation device arranged on the positioning unit, said rotation device bearing the camera such that it can rotate and being controlled by a second motor; and
given line-by-line scanning of the original, a position of the camera is adjusted by both motors such that the distance between the camera and each current line to be scanned is kept essentially constant.

52. A device according to claim 47 in which a rotatable mirror is placed in a beam path between camera and scanned lines is arranged on the lifting column.

53. A device according to claim 52 in which the mirror is adjusted along an axis of the lifting column.

54. A device according to claim 52 in which the camera is moved along the lifting column.

55. A device according to claim 43 in which an illumination unit that generates a ray band along a current scanned line is used to illuminate the original during the scan.

56. A device according to claim 55 in which the illumination unit comprises a plurality of LEDs.

57. A device according to claim 56 in which the LEDs generate polychromatic light.

58. A device according to claim 56 in which the illumination unit comprises a mirror that has a concavely curved, long, extended cylindrical section with two focal lines;
a plurality of LEDs which emit radiation in a direction of the mirror is arranged along one focal line; and
emitted radiation is collected on a second focal line, which corresponds to the current scanned line of the original.

59. A device according to claim 58 in which the cylindrical section of the mirror has a shape of an inner generated surface of an elliptical cylinder.

60. A device according to claim 58 wherein the first focal line of the mirror essentially coincides with a rotation center of the camera.

61. A method to scan an original, comprising the steps of:
resting an original to be scanned on a support surface;
providing a camera with an optoelectronic line sensor and scanning the original resting on the support surface line-by-line and generating electronic signals; and
during the scanning keeping an optical path length between the camera and each current line being scanned essentially constant.

62. A method to scan an original, comprising the steps of:
providing a support surface which supports the original to be scanned;
providing the camera with an opto-electronic line sensor; and
scanning the original line-by-line with the camera and keeping an optical path length between the camera and each current line being scanned essentially constant by changing an angle of the camera and moving the camera.

63. A device to scan an original, comprising:
a support surface for receiving the original to be scanned;
a camera provided with an opto-electronic line sensor that scans the original resting on the support surface line-by-line; and
a support for the camera keeping an optical path length between the camera and each current line being scanned essentially constant, and by changing an angle of the camera and moving the camera.
